(19) United States
(12) Patent Application Publication
(10) Pub. No.: US 2006/0148477 A1
(43) Pub. Date: Jul. 6, 2006

(54) Presence services in a wireless communications network

(75) Inventor: James Reilly, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/116,385

(22) Filed: Apr. 28, 2005

(30) Foreign Application Priority Data
Dec. 30, 2004 (GB) 0428533.4

(51) Int. Cl. H04Q 7/20

(52) U.S. Cl. 455/436

(57) ABSTRACT

A method of providing presence services in a mobile communications network, the method comprising: receiving a presence update message from a first user of a mobile device, said presence update message including a device activity presence attribute indicating activity of the mobile device; and transmitting the device activity presence attribute to a second user, which is arranged to display information representing the device activity.

### FIELD OF THE INVENTION

The present invention relates to the provision of presence services in a wireless communications network.

### BACKGROUND OF THE INVENTION

Communication systems providing wireless communication for user equipment are known. An example of a wireless system is the public land mobile network (PLMN). PLMNs are commonly based on cellular technology. In cellular systems, a base transceiver station (BTS) or similar access entity services mobile user equipment (UE) via a wireless interface between these entities. The communication on the wireless interface between the user equipment and elements of the communication network can be based on an appropriate communication protocol. The operation of the base station apparatus and other apparatus required for the communication can be controlled by one or several control entities.

One or more gateway nodes may be provided for connecting the cellular access network to other networks, for example to a public switched telephone network (PSTN) and/or other communication networks such as an IP (Internet Protocol) and/or other packet switched data networks. In such arrangements, the mobile communications network provides an access network enabling a user with wireless user equipment to access external networks, hosts, or services offered by specific service providers.

An example of the type of services that may be offered to a user such as a subscriber to a communication system are so-called presence services. Some of the communication systems enabled to offer presence services are known as internet protocol (IP) multimedia networks, via an IP multimedia core network subsystem (IMS). The IMS includes various network entities for the provision of multimedia services. IMS services are intended to offer, amongst other services, IP based packet data communication sessions between mobile user equipment. The packet data can carry presence information.

In a packet data network, a packet data carrier may be established to carry traffic flows over the network. An example of such a packet data carrier is a packet data protocol (PDP) context.

Various types of services are provided by means of different application servers (AS) over IMS. The IMS domain is for ensuring that multimedia services are adequately managed. The IMS domain commonly supports the session initiation protocol (SIP) as developed by the internet engineering task force (IETF). Session initiation protocol (SIP) is an application-layer control protocol for creating, modifying and terminating sessions with one or more participants (end points). SIP was generally developed to allow for the initiation of a session between two or more end points in the internet by making these end points aware of the session semantics. A user connected to an SIP based communication system may communicate with various entities of the communication system based on standardised SIP messages. User equipment or users that run certain applications on the user equipment are registered with the SIP backbone so that an invitation to a particular session can be correctly delivered to these end points.

Presence services which allow a notification about a person's availability or status to be sent directly to a recipient services are currently implemented according to the third Generation Partnership Protocol (3GPP) standards via the session initiation protocol (SIP). The recipient is termed a watcher. The person's availability and status is termed presence information and can include a variety of different types of information, including for example usage information, availability information, location information, device information, (that is nature of device, e.g. Personal Computer (PC), Personal Digital Assistant (PDA), mobile phone, etc), network information and capabilities, preferred medium (e.g. text, email, voice, video, etc), and preferences (e.g. security preferences). The presence information is supplied by a user equipment UE based on the user's use of the user equipment. At present however it is not possible to determine the active status of a user from the nature of the presence information which is provided.

It is an aim of the present invention to enhance the range of presence information which can be provided.

### SUMMARY OF THE INVENTION

According to an aspect of the present invention there is provided a method of providing presence services in a mobile communications network, the method comprising: receiving a presence update message from a first mobile device, said presence update message including a device activity presence attribute indicating activity of the mobile device; and transmitting the device activity presence attribute to a second mobile device, which is arranged to display information representing the device activity.

The information which represents the device activity can be displayed in the form of an icon which represents a particular activity. For example, the icon can take different forms depending on the type of activity which is being represented. Alternatively the information could be text information. As a further alternative, the information could comprise a link to a store holding the device activity information, for example to a suitable web page.

The device activity presence attribute (which can also be considered as a device usage presence attribute) can indicate a number of parameters, including: whether or not a user of the first mobile device has answered calls in a recent time period; whether or not a user interface of the first mobile device has been used in a recent time period; and whether the first mobile device has been charged in a recent time period.

The time period could be relatively long (e.g. tens of minutes, 1 hour, etc.) for many uses. Default settings could be used, but these could be configurable depending on the needs.

The mobile device can be arranged to keep timestamped lists of events giving rise to the above-defined parameters. It can also have a monitor process that monitors certain types of events and produces timestamped events. The polling frequency of such monitoring might have a default setting (e.g. every ½ hour) which can be configured.

Where the user of the first mobile device is playing a game, the second mobile device can be arranged to display an icon representing the game. In this sense, game information is a subclass of device activity.

Another aspect of the invention provides a mobile device arranged to provide presence services in a mobile communications network, the mobile device comprising: means for monitoring activity of the mobile device; means for formulating a presence update message including a device activity presence attribute representing said monitored activity; and means for transmitting the presence update message including said device activity presence attribute over a wireless communications channel.

Another aspect of the invention provides a mobile device arranged to monitor presence in a mobile communications network, the mobile device comprising: means for receiving a presence update message including a device activity presence attribute representing a monitored activity of another mobile device; and a display arranged to display information representing the device activity indicated by the device activity presence attribute.

A further aspect of the invention provides a server for providing presence services in a mobile communications network, the server comprising: means for receiving a presence update message from a first mobile device, said presence update message including a device activity presence attribute indicating activity of the mobile device; and means for transmitting the device activity presence attribute from the server to an application of a second mobile device, which is arranged to display information representing the device activity.

A small-scale presence server can run directly as an application or service in the second mobile device, or can be arranged in the network to transmit the device activity presence attribute to the second mobile device.

A further aspect of the invention provides a mobile communications system for providing presence services, the system comprising: a first user equipment including means for monitoring activity of the user equipment and for formulating a presence update message including a device activity presence attribute indicating said activity; a presence server for receiving said presence update message over a wireless channel; a second user equipment arranged to receive said device activity presence attribute from the presence server and to display information representing the device activity indicated by the device activity presence attribute.

For a better understanding of the present invention and to show how the same may be carried into effect reference will now be made by way of example to the accompanying drawings.

### BRIEF DESCRIPTION OF THE DRAWINGS

FIG. 1 is a schematic diagram of an architecture supporting presence services;

FIG. 1A is a schematic block diagram of elements of a user equipment;

FIG. 2 is a schematic diagram illustrating message exchange;

FIGS. 3 and 4 are examples of display icons for a user equipment; and

FIG. 5 is a schematic diagram of a number of users playing a game.

### DESCRIPTION OF THE PREFERRED EMBODIMENTS

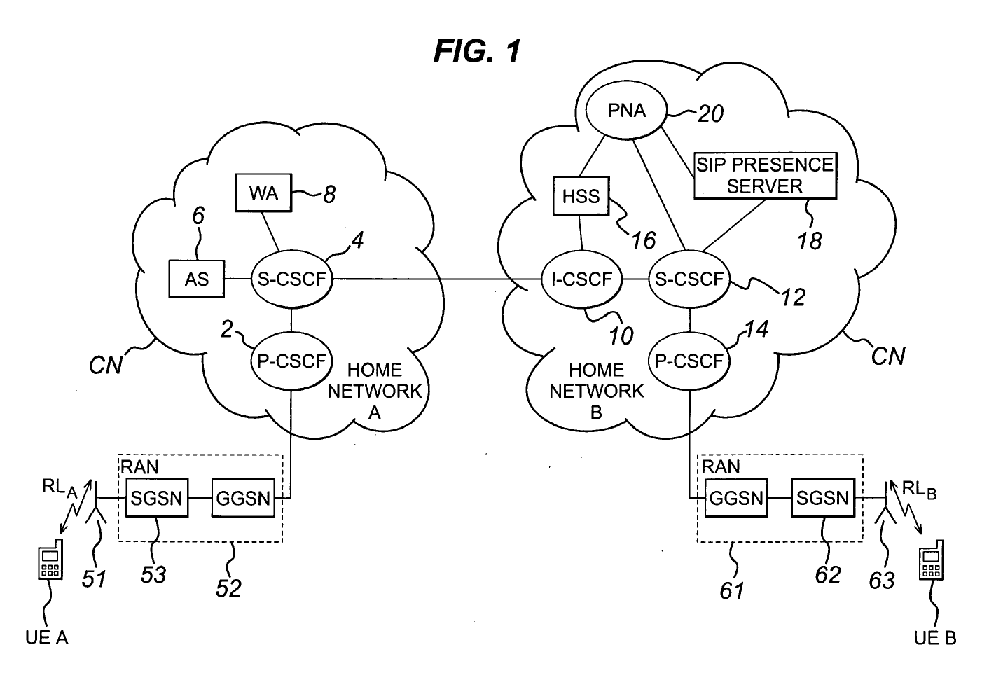

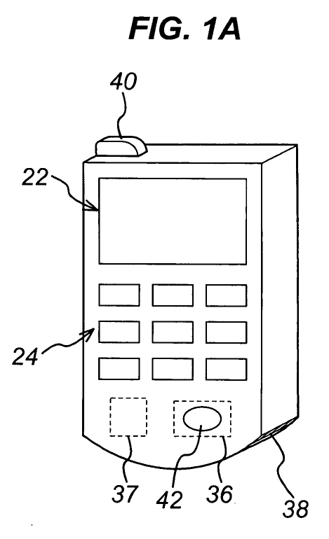

FIG. 1 is a schematic diagram illustrating an architecture of a mobile telecommunications network which can be used to support presence services. In particular, in accordance with embodiments of the invention, device activity is advised in the form of a device activity attribute delivered as a presence service.

Certain embodiments of the present invention will be described by way of example, with reference to the exemplifying architecture of a third generation (3G mobile communication system). However, it will be understood that embodiments may be applied to any other suitable forms of communication system.

The third generation partnership project (3GGP) has defined a reference architecture for the third generation (3G) core network which will provide the users of user equipment with access to multimedia and presence services. This core network is divided into three principal domains. These are the circuit switched (CS) domain, the packet switched (PS) domain and the internet protocol multimedia subsystem (IMS) domain.

FIG. 1 shows two communicating networks for offering IP multimedia services (including presence services) to IP multimedia network subscribers. IP multimedia subsystem (IMS) functionalities may be provided by a core network (CN) subsystem including various entities for the provision of the services.

A mobile communication system such as the 3G cellular system is typically arranged to serve a plurality of mobile user equipment, usually via a wireless interface between the user equipment and base stations of the communication system. The mobile communication system may logically be divided between a radio access network (RAN) and a core network (CN). The core network entities typically include various control entities and gateways for enabling the communication via a number of radio access networks and also for interfacing a single communication system with one or more communication systems such as with other cellular systems and/or fixed line communications systems.

In FIG. 1, the exemplifying general packet radio services operation environment comprise one or more sub-network service area, which are interconnected by GPRS backbone networks 52 and 61. A sub-network comprises a number of packet data service nodes (SN). In this embodiment, the service nodes will be referred to as serving GPRS support nodes (SGSN). Each of the SGSNs 53, 62 is connected to at least one mobile communication network, typically to base station systems 51, 63. Although not shown for clarity reasons, the connection may be provided by way of radio network controllers or other access system controllers such as base station controllers in such a way that packet services can be provided for mobile user equipment via several base stations.

Base stations 51 and 63 are arranged to transmit signals to and receive signals from mobile user equipment UE A and UE B of mobile users i.e. subscribers via respective wireless interfaces RL_{A}, RL_{B}. Correspondingly, each of the mobile user equipment is able to transmit signals to and receive signals from the base stations via the wireless interface. In the simplified representation of FIG. 1, the base stations 51 and 63 belong to respective radio access networks (RAN). In the arrangement shown, each of the user equipment UE A and UE B may access their respective network via the radio access network RAN associated with their base stations 51 and 63 respectively. It should be appreciated that, although FIG. 1 only shows the base stations of two radio access networks, a typical mobile communication network usually includes a number of radio access networks.

Communication systems have developed such that services may be provided for user equipment by means of various functions of the IMS networks that are handled by network entities and served by servers. In the current 3G wireless multimedia network architectures, it is assumed that several different servers are for handling different functions. These include functions such as the call session control functions (CSCF). The call session control functions can be divided into various categories such as a proxy call session control function (P-CSCF), interrogating call session control function (I-CSCF), and serving call session control function (S-CSCF).

The first user, user A, has a user equipment UE A which is in communication via a physical signalling channel or radio link RL_{A} with the logical and functional entities of its home network which is labelled Home Network A in FIG. 1. The Home Network A supports a proxy call session control function (P-CSCF) 2, a serving call session control function (S-CSCF) 4, an application server (AS), 6 and a watcher application (WA), 8. A watcher application is an entity that is subscribed or requests presence information from a session initiation protocol (SIP) presence server, 18. The serving call session control function 4 is in communication with a second network, which is labelled Home Network B and which is the home network of the second user, user B having a user equipment UE B. The second network supports an interrogating call session control function I-CSCF 10, a serving call session control function S-CSCF 12 and a proxy call session control function P-CSCF 14. In addition, the second network, Home Network B, has a home subscriber server 16, the session initiation protocol (SIP) presence server 18 and a presence network agent PNA 20. The presence network agent can collect presence information from a number of core network entities, and can combine information from various network entities to form more complete presence information. In this particular example it is assumed that the first user UE A is “watching” the second user UE B so that it is the user UE B which is supplying presence information to the first user UE A. Of course, it will readily be appreciated that all of the elements in the second network are mirrored in the first network so that the situation can be reversed and the second user UE B can watch the first user UE A. It will also be appreciated that similar but not identical functionality would be implemented if the respective users were visiting foreign networks rather than being in communication with their home networks.

User equipment within the radio access network may communicate with a radio network controller via radio network channels which are typically referred to as radio bearers. Each user equipment may have one or more radio channels open at any one time with the radio network controller. Any appropriate mobile user equipment adapted for internet protocol (IP) communication may be used to connect to the network. For example, a user may access the cellular network by means of user equipment such as a personal computer, personal data assistant (PDA), mobile station (MS), portable computer, combinations thereof or the like.

User equipment is used for tasks such as making and receiving phone calls, for receiving and sending data from and to a network and for experiencing for example multimedia content. As shown in FIG. 1A, user equipment is typically provided with a processor 36 and memory 37 for accomplishing these tasks. The user equipment includes an antenna 40 for wirelessly receiving and transmitting signals from and to base stations of the mobile communication network. The user equipment is also provided with a display 22 for displaying images and other graphical information for the user of the mobile user equipment. A speaker (not shown) may also be provided. The operation of the user equipment may be controlled by means of a suitable user interface 24 such as keypad, voice commands, touch sensitive screen or pad, combinations thereof or the like.

FIG. 1A is a schematic diagram showing components of a user equipment UE which can be used to monitor device usage. Usage of the user interface 24 can be monitored by the processor 36. The processor 36 is also connected to a charging socket 38 by means of which the user equipment UE can be charged. The processor 36 drives the display 22. The processor 36 is further connected to RF circuitry which receives RF signals via the antenna 40 representing calls and other data to the user equipment UE. In this way, the processor 36 can monitor incoming calls or other incoming data requests and how the user equipment UE is responding to those calls (i.e. answering them or not). In addition, the processor can monitor menu selections made by the user using the user interface 24 and display 22 to determine, for example, whether the user is listening to music or playing a game for example. The processor also has direct knowledge of which client applications or tasks are currently executing (e.g. a process table). A client application “Activity monitor” 42 executed on the processor monitors these activities and generates a device usage attribute which can be transmitted over the radio link RL.

The “Activity monitor” has default settings (which are re-configured by the owner or user of the device) about what types of activities, events, or other activity information may be monitored on their device, the frequency of such monitoring (e.g. once every 15 minutes, every hour, every 3 hours, every day, etc.). The “Activity monitor” may also have related security parameters and settings regarding how such information may be used, encrypted or forwarded outside of the device, etc.

Annexes A and B are conceptual examples of possible implementations of the invention using messages in XML format. In practice the format of messages can take any suitable form. The attached examples use timestamps, and running clocks may vary at different observers, so the assumption is made that all observers' clocks report roughly the same (‘close enough’) time. Other solutions could also be used.

The device usage attribute allows the second user to convey to the first user information about the activity status of the second user equipment UE B as will now be further described.

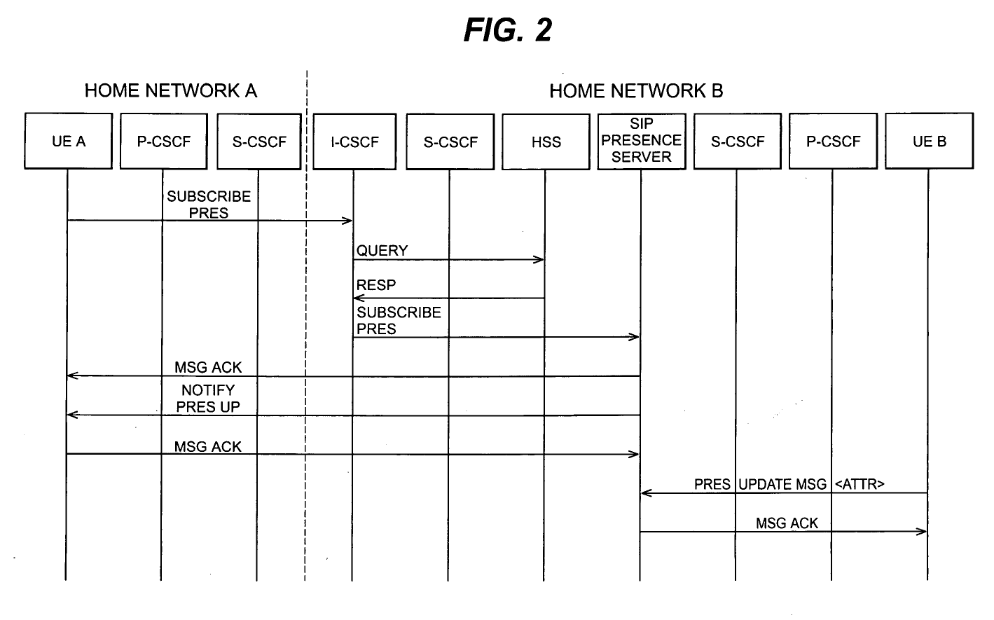

FIG. 2 is a diagram which illustrates in a simplified form the message exchange which takes place between the first user UE A and second user UE B when the first user UE A is watching the second user UE B. Firstly, the first user UE A issues a request which asks to be notified when the second user UE B is registered to the presence service. This message is labelled SubscribePres in FIG. 2. The message is received by the interrogating call session control function 10 which confirms via a query and response exchange with the home subscriber server (HSS) 16 that the second user UE B is registered at that network. Once this has been confirmed, the request SubscribePres is passed on to the SIP presence server 18. The SIP presence server sends an acknowledgement MsgAck to the first user UE A. If the second user UE B has not yet signed in, a message is returned from the SIP presence server which notifies the first user UE A that the second user UE B has not yet signed in. This message is labelled NotifyPresUp in FIG. 2. An acknowledge MsgAck is returned by the first user UE A to the SIP presence server 18. The second user UE B sends a presence update message to the SIP presence server when it is registered. The SIP presence server sends an acknowledgement MsgAck to the second user UE B. In addition, it issues a notify message NotifyPresUp to the first user UE A, which in this case transfers the presence update information which was included in the presence update message to the first user UE A who is watching the second user UE B. This message is not shown again in FIG. 2, so it will be appreciated that the order of the messages illustrated in FIG. 2 may vary depending on the particular circumstances.

User A can subscribe user's B presence if and only if user B has formed her/his presence information to the server. So when user A subscribes to user B's presence information it will get the acknowledgement MsgAck, and the latest presence information user B has sent to the server. Every time the subscriber B makes changes to the present information an update is sent to the watcher's.

The presence update message PressUpdateMsg which is sent by the second user UE B to the SIP presence server can identify one or more of several presence attributes <attr>. These attributes can identify their type and can include a unique identity which identifies the second user UEB in this case.

In case a user goes out of range, or turns their device off it might be useful in some cases for a separate server like the SIP presence server to store these attributes. Alternatively, they can be delivered directly to the first user and not stored. The latter approach possibly might be a more scalable solution, at least in some cases.

These attributes can identify presence information in a number of different category types, for example user, device or network specific. They can include usage information, availability information, location information, device information, network information and capabilities, preferred medium and preferences, for example security preferences.

In particular, in accordance with the described embodiment of the invention, a new type of presence attribute is defined which relates to device activity, rather than to device type. The device activity attribute allows the watcher to determine how active the second user has been with his user equipment. The attribute can be based on:

i) the last time the keypad on the user equipment was user;

ii) whether or not the device is being charged or has been charged recently;

iii) whether or not the user has answered his calls recently;

iv) the number of missed calls in a recent period.

In order to provide this information, the user equipment includes the mobile agent 42 which runs as a client in a processor of the user equipment to identify activities of the above type and to generate a presence attribute based on these activities.

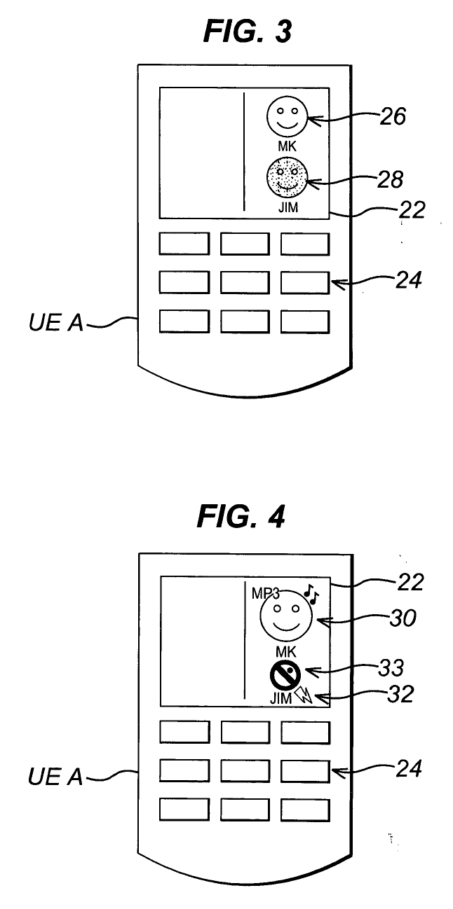

When the presence attribute is received at the first user equipment UE A, a representative icon can be displayed on the display 22 of the user equipment, the nature or appearance of the icon depending on the presence attribute. FIGS. 3 and 4 illustrate some examples of appropriate icons.

FIGS. 3 and 4 illustrate a user equipment UE A (in this case the watcher), illustrating the display 22 and the keyboard 24. A first icon 26 is associated with a user named Miko (Mk) and indicates that Miko is registered at the SIP presence server 18 and also that he has actively used his phone recently. That is, his device activity attribute has been provided to the SIP presence server 18 and transferred by the NotifyPresUp message to the first user UE A. The second icon 28 is associated with a user named Jim, and indicates that he is registered with the SIP presence server but that his presence attribute is not set, that is his phone has not been used in many hours, nor has he answered his calls in that time.

FIG. 4 illustrates an icon 30 which denotes that Miko is moving and that he is listening to MP3 music files. FIG. 4 also illustrates an icon 32 which illustrates that Jim has started to use his phone and specifically that he has started to play a game and an icon 33 which indicates that he has put his phone to silent mode so that he can concentrate on playing the game.

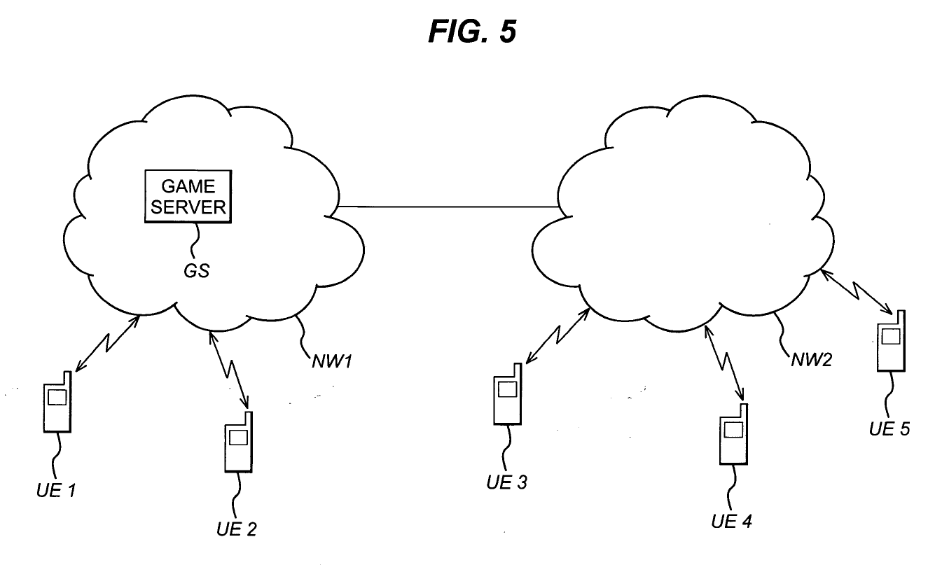

The device activity attribute is particularly useful in the context of playing games FIG. 5 illustrates the representative architecture where a number of users with user equipments UE1 . . . UE5 all wish to play a game which is supported by a game server GS in a first network, network 1. Two of the users UE1, UE2 are connected to the first network NW1, and three of the users UE3, UE4 and UE5 are connected to the second network, network 2. The first and second networks are in communication as already described above with reference to FIG. 1. One of the users could be appointed as a watcher, or all of the users could have a watching function as well as a presence updating function. The presence attributes can be used to indicate who is present and currently playing the game by use of the game icon 32.

When one person can tell that another person from some affinity group (e.g. a friend) is both on-line and playing a game, and that game supports some form of on-line competition, the user may wish to join that game or competition that is in progress, or perhaps just contact the other person to ask how the game is going. Even if the game is completely single-player, one might wish to independently play the game, in order to have something to make a later phone call discussion about.

This could also apply to other non-game application types as well. For example, Barbara sees that her friend (sister, daughter, club mate, etc.) Julia is present on-line and is running a chat application, or e-mail application, etc. She might then decide to also run the same, or similar, chat application, or e-mail application, etc. to interact with Julia or with someone else entirely (E.g. John sees that his child is on-line during a school weekday playing an on-line game on their phone when the family has agreed that such games can only be played on holidays: John might contact his child directly (phone call, chat, e-mail, SMS, by joining the game, etc.) or use an appropriate application to first interact with his wife to discuss whether she has given special permission for that day/time.)

If the activity indicator icon indicates the type (e.g. card game vs. racing game), or specific logo of a particular game title; a user might be even more interested (to just know that information, or to join a multiplayer session of that game with them.

In the future, it can be expected that presence services will become an integral part of the user interface for mobile phones. The existence of presence services enable a user to know when close friends, family, colleagues etc are on-line and available. It will become useful to combine various contextual information to help graphically display the state of ones presence to friends, family, colleagues and others. The kind of information that could be combined can, as described above, consist of:
Device usage: Has the keypad been used lately? Has the phone recently been inserted into a charger? Each of these indicates that the owner (or someone) is actively using the device.
Use of certain phone menus, may indicate the what the user is doing (e.g. taking a photo right now, listening to music/radio right now, playing a game, etc.)
Has the user answered calls recently? Has phone missed calls lately? Either way may help indicate whether the user is really there, or has left their phone at home (in the office) and is elsewhere at the moment.
If the user has changed their profile to “meeting” or “silent” they may be in a meeting or in a place where it's not possible to speak or reply to queries such as phones calls, IM or e-mail.

A sensor in the phone may be able to tell if the phone has been physically moved recently.

Once it becomes possible to see the “online presence” of others, it will be quite useful to see other contextual information about them as well. For example, if you call your spouse (child, friend) and get no answer and do this again and again, it is useful to know if they are just not answering the phone or whether they forgotten it at home again? Contextual information as above (lack of movement, lack of use, increase in unanswered calls, some calls answered but not other calls), could help to give graphical information about their state.

### Annexe A

```
<?xml version=“1.0”?>
<!DOCTYPE activity_indicators [
<!ELEMENT activity_indicators (timestamp, device)>
<!ELEMENT device (identifier,
              poweron*,
              profile*,
              recharge*,
              ui_usage*,
              spatials*,
              application*)>
<!ELEMENT identifier EMPTY>
<!ELEMENT poweron (timestamp)>
<!ELEMENT profile (timestamp)>
<!ELEMENT recharge (insert, remove*)>
<!ELEMENT insert (timestamp)>
<!ELEMENT remove (timestamp)>
<!ELEMENT ui_usage (ui_component_usage+)>
<!ELEMENT ui_component_usage (timestamp)>
<!ELEMENT spatials (spatial*)>
<!ELEMENT spatial (timestamp, position*, orientation*, acceleration*)>
<!ELEMENT timestamp (#PCDATA)>
<!ELEMENT position (#PCDATA)>
<!ELEMENT orientation (#PCDATA)>
<!ELEMENT acceleration (#PCDATA)>
<!ELEMENT application (timestamp+)>
<!ATTLIST timestamp type CDATA “most recent change”>
<!ATTLIST timestamp id CDATA “”>
<!ATTLIST identifier friendlyname CDATA “”>
<!ATTLIST remove percent CDATA “100%”>
<!ATTLIST profile type ( GENERAL |
                SILENT |
                DISCRETE |
                OUTDOOR |
                PAGER ) “GENERAL”>
<!ATTLIST ui_component_usage type ( KEYPAD |
                    POINTER |
                    TOUCHSCREEN |
                    COVER |
                    ATTACHMENT |
                    ACCESSORY |
                    OTHER ) “KEYPAD”>
<!ATTLIST spatials moving ( TRUE |
                  FALSE ) “FALSE”>
<!ATTLIST spatial type ( LASTKNOWN |
                PREVIOUS ) “LASTKNOWN” >
<!ATTLIST orientation units CDATA “degrees”>
<!ATTLIST acceleration units CDATA “m/s”>
<!ATTLIST application type ( SINGLEPLAYER_GAME |
                  MULTIPLAYER_GAME |
                  SOCIAL |
                  ENTERPRISE |
                  MEDIA |
                  OTHER) “OTHER”>
<!ATTLIST application networked (TRUE | FALSE) “FALSE”>
<!ATTLIST application active (TRUE | FALSE) “TRUE”>
<!ATTLIST application displayed (TRUE | FALSE) “FALSE”>
<!ATTLIST application name CDATA “”>
]>
<activity_indicators>
  <!-- timestamp for this message -->
  <timestamp id=“2” type=“update”>Wed Jun 30 14:34:29 GMT
2004</timestamp>
  <device>
    <identifier friendlyname=“Minna's phone” />
    <!-- When the device was most recently turned on -->
    <poweron>
      <timestamp>Wed Jun 30 10:59:29 GMT 2004</timestamp>
    </poweron>
    <!-- when the device's profile setting was last changed -->
    <profile type=“GENERAL”>
      <timestamp>Wed Jun 30 14:00:29 GMT 2004</timestamp>
    </profile>
    <!-- When some element of the device's UI (e.g. keypad)
          was last used; an approximation may be enough -->
    <ui_usage>
      <ui_component_usage type=“KEYPAD”>
        <timestamp>Wed Jun 30 14:34:29 GMT 2004</timestamp>
      </ui_component_usage>
      <ui_component_usage type=“ACCESSORY”>
        <timestamp>Wed Jun 30 14:20:29 GMT 2004</timestamp>
      </ui_component_usage>
    </ui_usage>
    <!-- When the device last moved somehow -->
    <spatials moving=“TRUE”>
      <!-- The time between measurements may be configureable (e.g. at
the source);
          e.g. once every 15 minutes, hour, 3 hours, day (or whatever)
-->
      <spatial type=“LASTKNOWN”>
        <timestamp>Wed Jun 30 14:34:29 GMT 2004</timestamp>
        <position>41°43′35″ N, 49°56′54″ W</position>
        <!-- e.g. yaw, pitch, roll -->
        <orientation units=“degrees”>[63, 30, 24]</orientation>
        <acceleration units=“m/s”>[0, 0, 0]</acceleration>
      </spatial>
      <spatial type=“PREVIOUS”>
        <timestamp>Wed Jun 30 13:29:25 GMT 2004</timestamp>
        <position>41°43′35″ N, 49°56′54″ W</position>
        <!-- e.g. yaw, pitch, roll -->
        <orientation units=“degrees”>[20, 20, 13]</orientation>
        <acceleration units=“m/s”>[0, −0.02, 0]</acceleration>
      </spatial>
    </spatials>
    <!-- Applications currently running in device and their activity
status -->
    <!-- e.g. Paintball is currently being played, and is active and
displayed -->
    <application type=“MULTIPLAYER_GAME” name=“Paintball”
            networked=“TRUE” displayed=“TRUE”>
      <timestamp id=“start time”>Wed Jun 30 12:45:29 GMT
2004</timestamp>
      <timestamp id=“recently used”>Wed Jun 30 14:34:29 GMT
2004</timestamp>
    </application>
  </device>
</activity_indicators>
```

### Annexe B

```
<?xml version=“1.0”?>
<!DOCTYPE activity_indicators [
<!ELEMENT activity_indicators (timestamp, device)>
<!ELEMENT device (identifier,
              poweron*,
              profile*,
              recharge*,
              ui_usage*,
              spatials*,
              application*)>
<!ELEMENT identifier EMPTY>
<!ELEMENT poweron (timestamp)>
<!ELEMENT profile (timestamp)>
<!ELEMENT recharge (insert, remove*)>
<!ELEMENT insert (timestamp)>
<!ELEMENT remove (timestamp)>
<!ELEMENT ui_usage (ui_component_usage+)>
<!ELEMENT ui_component_usage (timestamp)>
<!ELEMENT spatials (spatial*)>
<!ELEMENT spatial (timestamp, position*, orientation*, acceleration*)>
<!ELEMENT timestamp (#PCDATA)>
<!ELEMENT position (#PCDATA)>
<!ELEMENT orientation (#PCDATA)>
<!ELEMENT acceleration (#PCDATA)>
<!ELEMENT application (timestamp+)>
<!ATTLIST timestamp type CDATA “most recent change”>
<!ATTLIST timestamp id CDATA “”>
<!ATTLIST identifier friendlyname CDATA “”>
<!ATTLIST remove percent CDATA “100%”>
<!ATTLIST profile type ( GENERAL |
                SILENT |
                DISCRETE |
                OUTDOOR |
                PAGER ) “GENERAL”>
<!ATTLIST ui_component_usage type ( KEYPAD |
                    POINTER |
                    TOUCHSCREEN |
                    COVER |
                    ATTACHMENT |
                    ACCESSORY |
                    OTHER ) “KEYPAD”>
<!ATTLIST spatials moving ( TRUE |
                  FALSE ) “FALSE”>
<!ATTLIST spatial type ( LASTKNOWN |
                PREVIOUS ) “LASTKNOWN” >
<!ATTLIST orientation units CDATA “degrees”>
<!ATTLIST acceleration units CDATA “m/s”>
<!ATTLIST application type ( SINGLEPLAYER_GAME |
                  MULTIPLAYER_GAME |
                  SOCIAL |
                  ENTERPRISE |
                  MEDIA |
                  OTHER) “OTHER”>
<!ATTLIST application networked (TRUE | FALSE) “FALSE”>
<!ATTLIST application active (TRUE | FALSE) “TRUE”>
<!ATTLIST application displayed (TRUE | FALSE) “FALSE”>
<!ATTLIST application name CDATA “”>
]>
<activity_indicators>
  <!-- timestamp for this message -->
  <timestamp id=“1” type=“update”>Wed Jun 30 13:34:29 GMT
2004</timestamp>
  <device>
    <identifier friendlyname=“Minna's phone” />
    <!-- When the device was most recently turned on -->
    <poweron>
      <timestamp>Wed Jun 30 10:59:29 GMT 2004</timestamp>
    </poweron>
    <!-- when the device's profile setting was last changed -->
    <profile type=“SILENT”>
      <timestamp>Wed Jun 30 11:22:29 GMT 2004</timestamp>
    </profile>
    <!-- when the device was last inserted into an AC charger,
          and percentage re-charged when removed from AC
          charger -->
    <recharge>
      <insert>
        <timestamp>Wed Jun 28 11:59:29 GMT 2004</timestamp>
      </insert>
      <remove percent=“54%”>
        <timestamp>Wed Jun 28 12:59:29 GMT 2004</timestamp>
      </remove>
    </recharge>
    <!-- When some element of the device's UI (e.g. keypad)
          was last used; an approximation may be enough -->
    <ui_usage>
      <ui_component_usage type=“KEYPAD”>
        <timestamp>Wed Jun 30 13:22:29 GMT 2004</timestamp>
      </ui_component_usage>
    </ui_usage>
    <!-- When the device last moved somehow -->
    <spatials moving=“TRUE”>
      <!-- The time between measurements may be configureable (e.g. at
the source);
            e.g. once every 15 minutes, hour, 3 hours, day (or
            whatever)
-->
      <spatial type=“LASTKNOWN”>
        <timestamp>Wed Jun 30 13:22:29 GMT 2004</timestamp>
        <position>41°43′35″ N, 49°56′54″ W</position>
        <!-- e.g. yaw, pitch, roll -->
        <orientation units=“degrees”>[45, 0, 0]</orientation>
        <acceleration units=“m/s”>[0, 0, 0]</acceleration>
      </spatial>
      <spatial type=“PREVIOUS”>
        <timestamp>Wed Jun 30 12:22:25 GMT 2004</timestamp>
        <position>41°43′35″ N, 49°56′54″ W</position>
        <!-- e.g. yaw, pitch, roll -->
        <orientation units=“degrees”>[270, 45, 120]</orientation>
        <acceleration units=“m/s”>[0.01, −0.02, 0.01]</acceleration>
      </spatial>
    </spatials>
    <!-- Applications currently running in device and their activity
status -->
    <!-- e.g. Multiplayer Paintball is currently being played,
            and is active and displayed -->
    <application type=“MULTIPLAYER_GAME”
              name=“Paintball”
              networked=“TRUE” displayed=“TRUE”>
      <timestamp id=“start time”>Wed Jun 30 12:45:29 GMT
2004</timestamp>
      <timestamp id=“recently used”>Wed Jun 30 13:34:29 GMT
2004</timestamp>
    </application>
    <application type=“SOCIAL” name=“Chat” networked=“TRUE”
              displayed=“TRUE”>
      <timestamp id=“start time”>Wed Jun 30 12:14:26 GMT
2004</timestamp>
    </application>
    <!-- e.g. Gallery is not currently being displayed on the device's
UI,
          it may be e.g. stacked in the list of semi-inactive (or
background)
          tasks/processes -->
    <application type=“OTHER” name=“Gallery” networked=“FALSE”
              displayed=“FALSE”>
      <timestamp id=“start time”>Wed Jun 30 11:00:08 GMT
2004</timestamp>
    </application>
  </device>
</activity_indicators>
```

What is claimed is:

1. A method of providing presence services in a mobile communications network, the method comprising:
receiving a presence update message from a first user of a mobile device, said presence update message including a device activity presence attribute indicating activity of the mobile device; and
transmitting the device activity presence attribute to a second user, which is configured to display information representing the device activity.

2. A method according to claim 1, wherein the step of transmitting comprises transmitting the device activity presence attribute indicating whether a user of a first mobile device has answered calls in a recent time period.

3. A method according to claim 1, wherein the step of transmitting comprises transmitting the device activity presence attribute indicating whether a user interface of a first mobile device has been used in a recent time period.

4. A method according to claim 1, wherein the step of transmitting comprises transmitting the device activity presence attribute indicating whether a first mobile device has been charged in a recent time period.

5. A method according to claim 1, wherein a user of a first mobile device is playing a game, and said information is an icon displayed at a second mobile device which represents the game.

6. A method according to claim 1, which comprises the step of:
transmitting a subscribe request message from a second mobile device to a presence server to determine whether a first mobile device has subscribed to provide presence services.

7. A method according to claim 6, wherein the subscribe request message is transmitted according to a session initiation protocol (SIP).

8. A method according to claim 1, wherein the step of receiving comprises receiving the presence update message transmitted over a wireless channel.

9. A method according to claim 1, wherein the step of receiving comprises receiving the presence update message including at least one additional presence attribute selected from the group comprising usage information, availability information, location information, device information, network information, preferred medium information and preferences information.

10. A method according to claim 1, wherein said information representing the device activity is selected from the group comprising an icon, text, and a link to a store holding said device activity information.

11. A mobile device configured to provide presence services in a mobile communications network, the mobile device comprising:
means for monitoring activity of the mobile device;
means for formulating a presence update message including a device activity presence attribute representing said monitored activity; and
means for transmitting the presence update message including said device activity presence attribute over a wireless communications channel.

12. A mobile device according to claim 11, which comprises a display configured to display information representing a device activity indicated by the device activity presence attribute on receipt of a presence update message from a further mobile device.

13. A mobile device according to claim 12, wherein said information is selected from the group comprising an icon, text, and a link to a store holding said device activity information.

14. A mobile device according to claim 11, wherein said means for monitoring device activity includes means for monitoring whether a user has answered calls in a recent time period.

15. A mobile device according to claim 11, wherein the means for monitoring device activity includes means for monitoring whether a user interface of the mobile device has been used in a recent time period.

16. A mobile device according to claim 11, wherein the means for monitoring device activity includes means for monitoring whether the mobile device has been charged in a recent time period.

17. A mobile device according to claim 12, wherein said information comprises an icon representing a game which is being played by said further mobile device.

18. A mobile device configured to monitor presence in a mobile communications network, the mobile device comprising:
means for receiving a presence update message including a device activity presence attribute representing a monitored activity of another mobile device; and
a display configured to display information representing a device activity indicated by the device activity presence attribute.

19. A server for providing presence services in a mobile communications network, the server comprising:
means for receiving a presence update message from a first mobile device, said presence update message including a device activity presence attribute indicating activity of the first mobile device; and
means for transmitting the device activity presence attribute to an application of a second mobile device, which is configured to display information representing device activity.

20. A mobile communications system for providing presence services, the system comprising:
a first user equipment including means for monitoring activity of the first user equipment and for formulating a presence update message including a device activity presence attribute indicating said activity;
a presence server for receiving said presence update message over a wireless channel; and
a second user equipment configured to receive said device activity presence attribute from the presence server and to display information representing the activity indicated by the device activity presence attribute.

21. A mobile communication system according to claim 20, wherein said information is selected from the group comprising an icon, text, and a link to a store holding said device activity information.
